(19) United States
(12) Patent Application Publication
(10) Pub. No.: US 2003/0106589 A1
(43) Pub. Date: Jun. 12, 2003

(54) Unidirectional valve for flexible packages, preferably made with laminar plastic materials

(76) Inventor: Victor Eduardo Basso, Buenos Aires (AR)

Correspondence Address: Finnegan, Henderson, Farabow,, Garrett & Dunner, L.L.P., 1300 I Street, N.W., Washington, DC, 20005-3315, US

(21) Appl. No.: 10/006,701

(22) Filed: Dec. 10, 2001

(51) Int. Cl. F16K 15/14

(52) U.S. Cl. 137/512.15; 137/852

(57) ABSTRACT

Unidirectional valve for flexible packages, preferably made with laminar plastic materials.

It is a valve made of a sheet attached to the external face of the package with a window positioned to coincide with an orifice in it, superimposed by another sheet that covers its window and is attached to the first [illegible] of two of its edges, with the transversal edges unattached, and forming a channel for gases to escape, when the internal overpressure separates the exterior sheet from the perforated wall, which in [the] passive position is closed by said sheet under external atmospheric pressure, guaranteeing the escape of gases generated by the product and preventing the destructive entry of outside air.

The present invention relates to a unidirectional valve, which is especially useful for flexible sack-type packages made with flexible laminar plastic materials such as those generally used to package coffee, sugar, baked goods, dog food, powdered milk, and so forth.

Generically, unidirectional valves are already well known and are essentially valves that permit the passage of fluid in just one direction, while preventing the passage of air in the opposite direction. The purpose of using this type of valve is to permit gases that may be produced by a product which is already packaged to escape from the package but to prevent the outside air from entering the package, since that would surely cause the product to deteriorate. In point of fact, there are many products that generate different types of gases. A typical example is coffee, which emits a gas, carbonic anhydride, after being roasted, and if the package is closed that gas can cause expansion and eventually burst the walls of the package, which creates obvious difficulties. To prevent these types of problems, at present, coffee is generally packaged 48 hours after roasting, since by then it has stopped emitting gas. But this has a deleterious effect on the properties of the coffee, which will not be the same as they would have been if it could have been packaged immediately after roasting, since the aromas are lost upon exposure to the air.

The valve proposed for the present invention allows the gas to escape until the coffee stops emitting gases and then, when the internal pressure disappears, the valve closes. In other words, the package is closed and the outside air cannot enter. One of the effects this achieves is that the oxygen inside the package can escape, but the oxygen outside cannot enter, so, since the oxygen in the space at the top of the package escapes, the product has a longer shelf life, inasmuch as that oxygen causes oxidation processes and deterioration of the product that affect its quality.

During the life of the package, outside air or oxygen cannot enter the package, since the valve's channel does not inflate or does not open with external pressure; rather, it rises with the internal pressure when the user, for any reason, presses the package and generates pressure to force out the gas or air in said package. Thus, the valve remains closed until the internal pressure exceeds a predetermined value, for example, approximately 15 millibars, and at that point, the channel inflates and the valve opens.

This feature is especially useful, for example, when the user wants to smell the aroma of the product contained in said package without having to open or damage said package. So, this unidirectional valve which is now proposed is also a new element for marketing the product.

The proposed valve is also useful for packaging various baked goods and in some medical applications.

This type of unidirectional valve is also necessary when products are shipped to countries at very high altitudes, since they inflate with less internal pressure and can cause destruction of the package [sic].

In addition, this valve allows internal air to escape, so the packages deflate and take up less space, producing less volume, and therefore the transportation cost is lower.

Moreover, attaching it to the package is extremely simple, since it can be joined, as will be explained in detail, directly to the sheet which will constitute the walls of the package. That is, it can be attached before the package is constructed by means of two sheets that are applied as part of an operation involving perforation and joining without having to bond them to the package, so that the cost of the equipment involved in this operation is much lower.

Essentially, the proposed unidirectional valve has the aforementioned unidirectional capacity based on two very thin flat sheets.

There are unidirectional plastic valves that essentially allow gas to escape from packages, consisting of two 100-micron sheets joined together at the edges with both joined to the wall of the package, leaving a central area unjoined above the gas escape orifice and an escape channel, the means of closure being a liquid contained between the two sheets, which causes pressure to close when air enters through the aforementioned orifice, with gases being expelled when their internal pressure reaches the point of being able to deform the capsule containing liquid.

The complexity of assembling this valve, distributed by the Hesser company of Germany, and the machine that does the work, can be inferred from what has been set forth, which translates into high cost as well as the voluminousness thereof.

Another well-known achievement is based on a more or less rigid plastic part attached to a window in the package, on whose exterior is a film covering an orifice.

In this case, a drop of thick oil must be added to the film as a removable adhesive, since the closure of the escape channel formed between the latter and the part is not sufficient to prevent air from entering, resulting in very frequent failures.

The original element of the valve is that, by using very thin sheets, the external pressure acts on the outside sheet, superimposed on a window cut in the lower sheet, coinciding with perforations on the package, and results in the closing of the valve, since a small external overpressure is sufficient to close it, and a small internal overpressure is sufficient to open it and let gas escape from the package.

The proposed solution will offer significant improvement vis-a-vis the problems associated with the prior art connected with unidirectional valves.

The fundamental principle on which the proposed valve is based is the extreme thinness of the sheets that are joined together by the aforementioned external overpressure. This is why the unidirectional valve of the present invention solves the aforementioned problems: the very thin sheets produce a very sure unidirectionality, avoiding failures, and are basically presented on a roll with three laminated materials superimposed on each other. A first base laminar material or siliconed liner is a material that only transports the valve to the packager, protecting the adhesive-treated face, which is then removed and discarded after the operation. The two remaining materials are those that ultimately go into the package, whether it is flexible or rigid, one of them making up a lower layer which is attached, with an adhesive, to the walls of the package; this lower piece has a window through which the gas inside will escape, and on top of it, the other layer, which makes up an upper layer, is attached.

The edges of that window will produce the closure against the upper layer, the one that is attached only on the sides, leaving a central channel through which the gas will pass when the internal pressure causes it to do so.

The improvements the present invention makes in the unidirectional valve are summarized as follows:

a) it does not permit the gas or air in the external environment to enter the package;

b) it keeps the packages from bursting when the packaged products generate gases that cannot escape;

c) it allows roasted coffee to be packaged immediately, keeping its properties unchanged;

d) it retains the aroma better, allowing it to escape only on purpose;

e) it makes the package a permanent degasifying silo;

f) it expands the distribution area and reduces returns;

g) it reduces the volume of multiple packages and, therefore, the cost of transporting them;

h) it compensates for the difference in atmospheric pressure in high altitude locations;

i) it allows for advertising or a message on its face;

j) it is economical.

These are just some of the significant improvements of the present invention, as will become evident through this description, which will be in keeping with the accompanying drawings, which are illustrative only, and, in some respects, limitative, and which will demonstrate that:

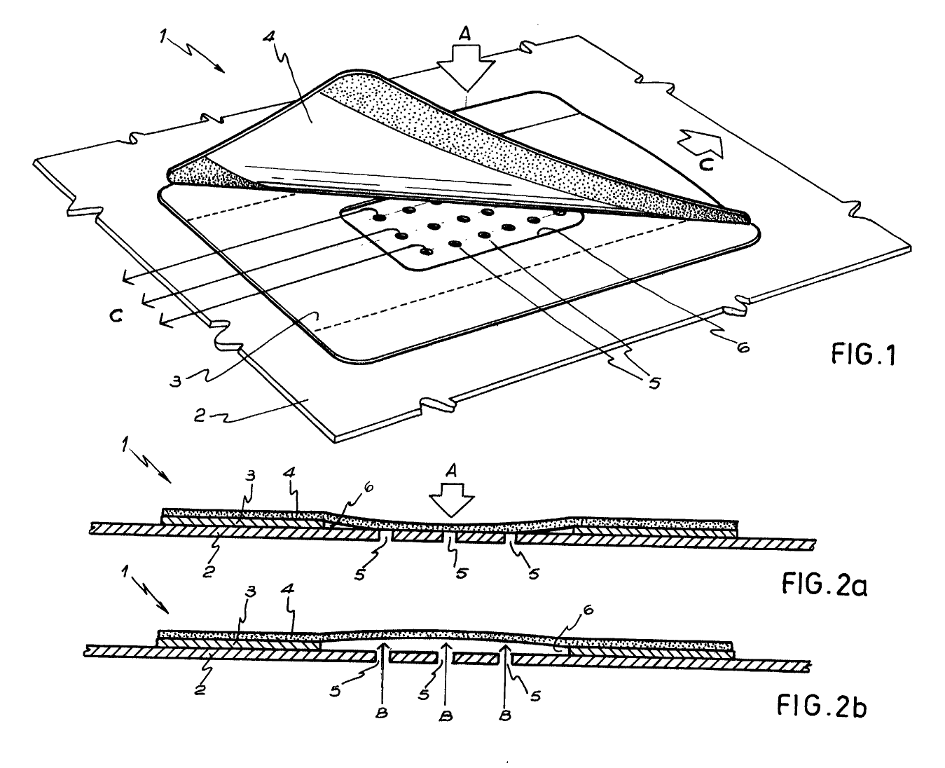

FIG. 1 is a schematic view illustrating the proposed valve with its component sheets, showing, with arrows, how the gas is channeled from the inside—B—of the package to the outside—C—thereof, under external pressure.

FIGS. 2A and 2B are respective cuts illustrating in detail how the sheets act when the package is closed and when internal pressure, which must escape, is generated.

Completely in keeping with what has been described and illustrated, we see that the proposed unidirectional valve marked as general reference 1 includes a laminar material that makes up the wall of the package, shown in the figures as reference 2, and of which only a part is illustrated, but it is understood that this material extends to the entire package. During the process of manufacturing the package, the laminar material of which it is made is perforated, defining the orifices marked as reference 5. FIGS. 2A and 2B show that said orifices are made as segmented portions, but in reality they can also have another configuration and be, for example, a single circular or rectangular orifice as convenient and in accordance with the product manufacturer's work method.

Next, the valve per se is constructed of two sheets marked as references 3 and 4, the first of which is affixed to the laminar material 2 with which the package is made, while the latter sheet 4 is in turn affixed to sheet 3. Said sheet 3 contains a window 6 which fully covers the orifices 5, made in the laminar material 2 of the package, while sheet 4 covers said opening. Since sheet 3 and sheet 4 are very thin, for example, although that should not be interpreted restrictively for implementation of the proposed valve, while the material of which the package wall is made can be a laminar material approximately 100 microns thick, the first sheet 3 attached to this layer 2 is approximately 30 microns thick while the second and last sheet, 4, is 50 microns thick. This thinness means that, under normal conditions, sheet 4 is always closing the orifices 5 on the package wall 2. When, because of pressure, outside air tries to enter the package, it will be prevented from doing so due to the constant support said sheet 4 provides to the orifices 5, functioning as a very low cost, high efficiency unidirectional valve.

It is clear from all the above that the unidirectional valve of the present invention functions as follows:

The valve opens when the user generates internal pressure from the gas contained in the package, for example, by pressing on said package, to smell the aroma of the product. So, when said internal pressure exceeds a certain value, the gas will flow out through the orifices 5, via the valve's channel.

Under normal conditions, that is, when the internal pressure of the product is lower than the external atmospheric pressure, the sheet, because of its extreme thinness, tends to adhere to the outside face of sheet 2, of which the wall of the package is made, and consequently, to its orifices, 5, so the valve closes automatically.

To minimize the costs of attaching the proposed valve, it can be placed during the process of manufacturing the laminar material with which the package is made. In point of fact, these laminar materials are produced in very long rolls which are placed on the packaging machines, which are the machines that fold said laminar material to construct the package, at the same time various bonds are produced, thus shaping the package 4, then measuring out the product to be packaged. Before that packaging process begins, the valve can be placed directly on the laminar material on the roll so it enters the packaging machine with the valve in place. For this, once the roll of laminar material is printed with all the color and design features in keeping with the packaging of the product in question, that spool of laminar material will be processed with a device designed for that purpose, which is an applicator made to produce a perforation, which in this case corresponds to the orifices, 5, on the spooled laminar material, and at the same time placing the valve, which is similar to a stamp. It should be said that it has an adhesive that places said valve to correspond with the orifice which has been made with the laminar material 2.

The unidirectional valve for flexible packages, preferably made with laminar plastic materials, as described and illustrated, is included under the scope of protection of the present patent, which is essentially determined by the text of the following claims.

Having thus specifically described and established the nature of the present invention and the way it must be implemented, the following are claimed as exclusive property and right:

1. Unidirectional valve for flexible packages, preferably made with laminar plastic materials, attached to the wall of the package to permit the escape of gases produced inside and to prevent the entry of outside air, being a very thin plastic sheet applied in one piece to the external face of the package wall, with a window positioned to coincide with at least one orifice on that wall, [and] having superimposed [on] said sheet another of similar thickness that covers its window and is attached to it along the length of two of its opposite edges, like a bridge, with the transversal edges unattached, forming a path for gases to escape when the internal overpressure separates the exterior sheet from the perforated wall, which in [the] passive position is closed by said sheet under external atmospheric pressure.

2. Unidirectional valve for flexible packages, preferably made with laminar plastic materials as claimed in clause 1, distinguished by the upper layer being attached to the lower layer with window, leaving just one edge unattached, forming a single path for gases to escape.
